(19) United States
(12) Patent Application Publication
(10) Pub. No.: US 2006/0011700 A1
(43) Pub. Date: Jan. 19, 2006

(54) Vibration welding machine

(76) Inventors: Tim Trabandt, Neuffen (DE); Michael Jauch, Moessingen (DE)

Correspondence Address: FLYNN THIEL BOUTELL & TANIS, P.C., 2026 RAMBLING ROAD, KALAMAZOO, MI, 49008-1631, US

(21) Appl. No.: 11/181,044

(22) Filed: Jul. 14, 2005

(30) Foreign Application Priority Data
Jul. 15, 2004 (DE) 102004035146.5

(51) Int. Cl. B23K 1/06

(52) U.S. Cl. 228/1.1; 228/110.1

(57) ABSTRACT

A vibration welding machine includes a machine frame, in which a locating unit for a bottom tool and a locating part for a top tool are arranged, the locating part for the top tool having a multiplicity of fastening points which are arranged in a distributed manner over its base area and to which the top tool can be fastened by means of a corresponding number of fastening means. The top tool is provided with fastening receptacles on its top side facing the locating part, and fastening means are arranged in the locating part, which fastening means project downward toward the top tool and can be connected to the fastening receptacles during fitting of the top tool.

### FIELD OF THE INVENTION

The invention relates to a vibration welding machine having a machine frame, to which a locating unit for a bottom tool and a locating part for a top tool are assigned, the locating part for the top tool having a multiplicity of fastening points which are arranged in a distributed manner over its base area and to which the top tool can be fastened by means of a corresponding number of fastening means.

### BACKGROUND OF THE INVENTION

Such a vibration welding machine is known in general from a brochure “Vibrations-Schweiβmaschinen” [vibration welding machines] of the applicant. The known vibration welding machine has a machine frame in which a locating unit in the form of an elevating table is arranged in a displaceable manner. The locating unit carries a bottom tool. Held above the locating unit is a locating part which serves to fasten a top tool. The locating part for the top tool is held on a portal plate in an oscillating manner by means of springs, this portal plate being isolated from the machine frame in terms of oscillations but nonetheless being connected to the latter. The locating part therefore forms an oscillation head of a spring-mass system, which is actuated by electromagnets which can be loaded alternately. The portal plate is also part of the oscillation system. The oscillation of the spring-mass system is effected at resonant frequency. The top tool is fastened by means of a multiplicity of fastening screws in the locating part serving as oscillation head. To this end, the locating part has tapped holes which are incorporated in the locating part from an underside of the locating part. The top tool is provided with holes through which the fastening screws are inserted from below and screwed into the tapped holes of the locating part. The fitting of the top tool on the locating part is effected by at least one operator as overhead fitting.

### SUMMARY OF THE INVENTION

The object of the invention is to provide a vibration welding machine of the type mentioned at the beginning which permits simplified fitting of a top tool.

This object is achieved in that the top tool is provided with fastening receptacles on its top side facing the locating part, and that fastening means are arranged in the locating part, which fastening means are directed toward the top tool and are matched to the fastening receptacles in such a way that the fastening means can be connected to the fastening receptacles during fitting of the top tool. According to the invention, the fastening functions are reversed compared with the prior art. The top tool is now provided with fastening receptacles, which are open toward the side facing the locating part in order to be able to accommodate the fastening means which are arranged in the locating part and project downward toward the top tool. It is essential to the invention that the fitting of the top tool on the locating part now no longer has to be carried out as overhead fitting by an operator, but rather fastening of the top tool from above the locating part is made possible.

Simplified fitting is achieved as a result. In addition, the top tool no longer has to be provided with through-holes in order to permit the fitting. On the contrary, the top tool, on its underside facing the bottom tool, can be provided without functional surfaces for corresponding fitting options, since the fastening receptacles are provided on the top side of the top tool.

In a development of the invention, the fastening means are accessible from a top side of the locating part and have tool application surfaces which enable a fastening tool to be applied from above. As a result, fitting by means of a corresponding fastening tool from above the locating part is made possible in a simple manner.

In a further development of the invention, the fastening means provided are cap screws which are held suspended in through-holes of the locating part and project downward beyond an underside of the locating part. The through-holes are preferably of stepped design in order to ensure the suspended arrangement of the cap screws.

In a further development of the invention, at least one screwdriver is arranged as fastening tool on the machine frame, which screwdriver is provided with a rotary drive and can be fed in toward the cap screws for a screw-in or unscrewing operation. The screwdriver is preferably arranged permanently on the machine frame and allows automatic fitting of the top tool.

In a further development of the invention, the screwdriver is arranged in a guide arrangement in such a way as to be traversable in a plane parallel to a surface of the locating part. As a result, it is possible to use a small number of screwdrivers, preferably one to two, for the screwing operations of all the cap screws.

In a further development of the invention, the guide arrangement is provided with at least one actuator.

In a further development of the invention, a reciprocating drive is assigned to the screwdriver in order to vertically displace the screwdriver. The various drives permit fully automatic fitting or removal of the top tool. The reciprocating drive preferably serves merely to feed the screwdriver in toward the corresponding screw head in the stroke direction. The subsequent follow-up of the screwdriver for the screw-in or unscrewing operation of the respective cap screw is effected via spring preloading of a shank of the screwdriver by the screwdriver being arranged in an axially movable manner and being permanently acted upon by corresponding compression-spring forces.

In a further development of the invention, a control device is provided which activates the at least one rotary drive and/or the at least one reciprocating drive and/or the at least one actuator. As a result, it is possible to carry out fully automatic fitting or removal by means of predeterminable control programs.

In a further development of the invention, a displacement sensor is assigned to the guide arrangement and/or a stroke sensor is assigned to the reciprocating drive, said displacement sensor and said stroke sensor being connected to the control device. As a result, the displacements of the at least one screwdriver can be detected and processed in the control device.

In a further development of the invention, a torque sensor which detects a tightening torque of the rotary drive is assigned to the screwdriver. In this way, a further physical actual variable can be detected, which can be appropriately evaluated.

In a further development of the invention, the control device has a microprocessor which compares actual values of the sensors with setpoints of a characteristics memory and activates the drives as a function of the result of the respective setpoint/actual-value comparison. This makes possible fully automatic open-loop or closed-loop control of corresponding operations for fitting or removing the top tool.

In a further development of the invention, a spatial coordinate system in which at least one reference position of the at least one screwdriver and positions of the cap screws are defined in terms of coordinates is stored in the characteristics memory. Input of these positions into a corresponding memory of the control device or of the microprocessor is necessary in order to be able to define the movements of the screwdriver in a fully automatic manner.

### BRIEF DESCRIPTION OF THE DRAWINGS

Further advantages and features of the invention follow from the claims and from the description below of a preferred exemplary embodiment of the invention, which is described with reference to the drawings, in which:

FIG. 1 shows an embodiment of a vibration welding machine according to the invention in a perspective illustration,

FIG. 2 shows the vibration welding machine according to FIG. 1 in a front view,

FIG. 3 shows the vibration welding machine according to FIGS. 1 and 2 in a plan view,

FIG. 4 shows a sectional illustration of the vibration welding machine according to FIG. 3 along section line IV-IV in FIG. 3,

FIG. 5 shows an enlarged detail of the sectional illustration according to FIG. 4,

FIG. 5a shows a further enlarged detail V from FIG. 5, and

FIG. 6 shows a perspective, enlarged illustration of a top region of the vibration welding machine according to FIG. 1, with a pressure circuit diagram being incorporated.

### DETAILED DESCRIPTION OF THE INVENTION

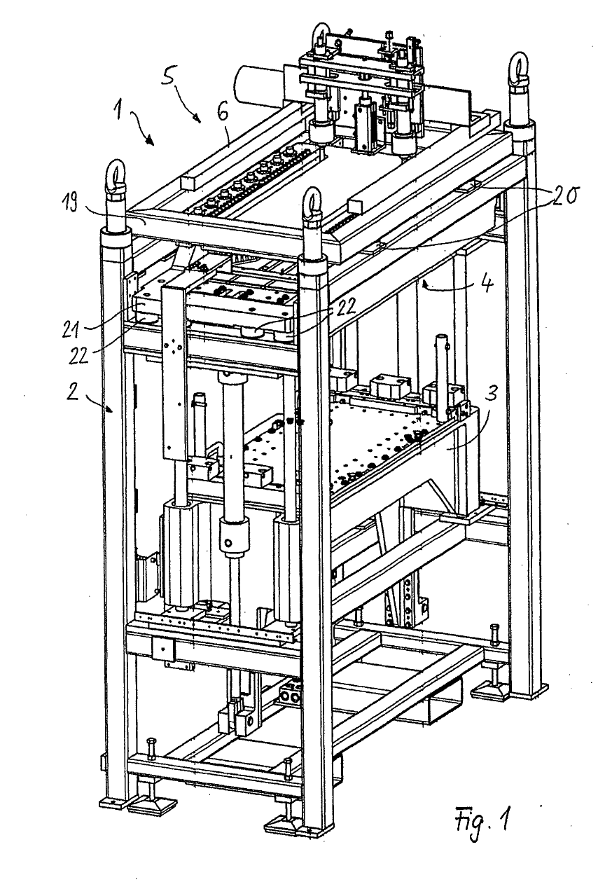

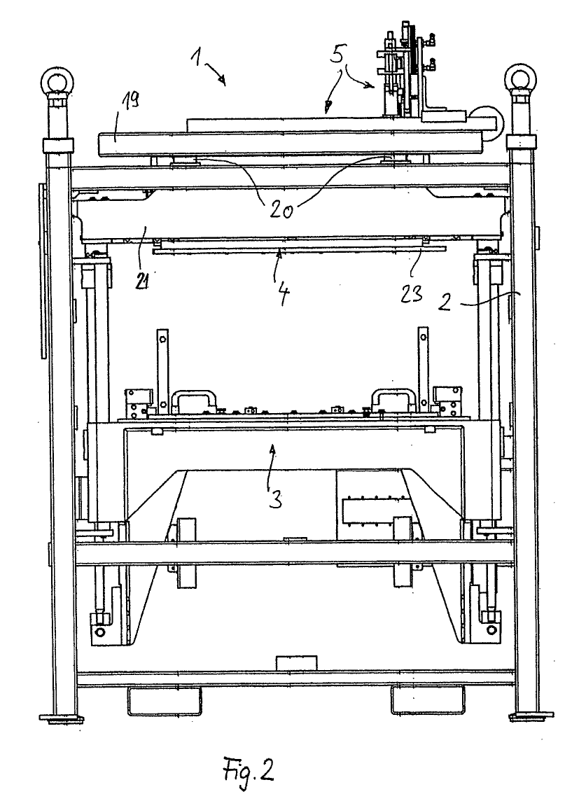

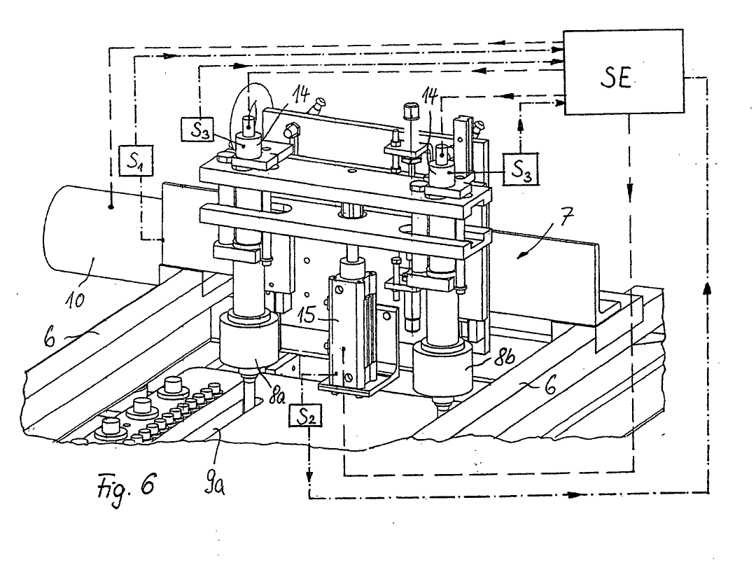

A vibration welding machine 1 according to FIGS. 1 to 6 serves for welding plastic parts. In particular, components made of all types of thermoplastics, preferably high-temperature-resistant plastics, low-viscosity materials, plastics with high filler proportion, and also different materials such as, in particular, wood composites or textiles can be welded by means of the vibration welding machine.

The vibration welding machine 1 has a machine frame 2 in which an elevating table 3 is arranged in an elevating manner, this elevating table 3 serving as a locating unit for a bottom tool.

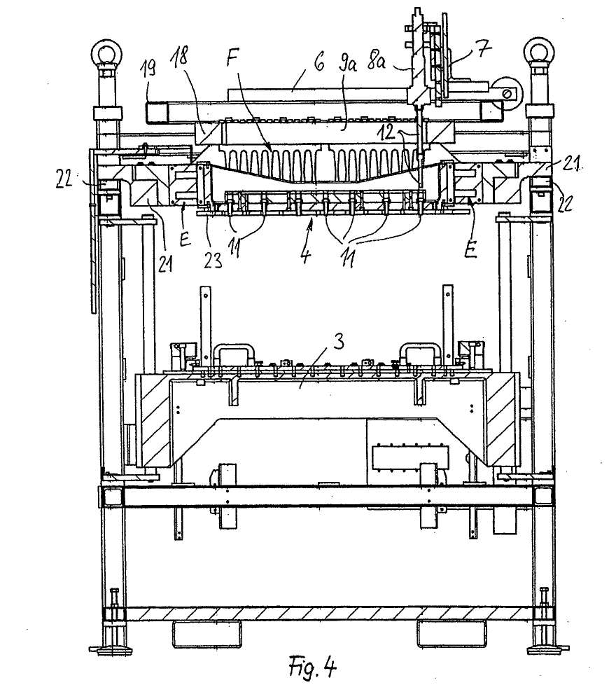

Above the elevating table 3, a locating part 4 for a top tool is held in an oscillating manner on a spring arrangement F, the locating part 4 forming an oscillation head. As can be seen with reference to FIG. 4, electromagnets E are arranged on both sides of the locating part 4 serving as oscillation head, and these electromagnets E are loaded alternately and thus bring the locating part 4 suspended on the spring arrangement F to resonant frequency. The spring arrangement F is held on a portal bridge 18, 21, which is part of the oscillation system, i.e. part of the spring-mass system of the vibration welding unit. The portal bridge 18, 21 is arranged on the machine frame 2 and is isolated in terms of oscillations from the machine frame by damping elements 22, preferably rubber dampers. A fastening tool arrangement 5, which will be dealt with in more detail below, is connected to the machine frame 2 by means of a supporting frame 19 and is isolated in terms of oscillations from the oscillation system, i.e. from the spring-mass system, by damping elements 20, which are designed in particular as rubber buffers.

A corresponding vibration welding operation is thereby initiated. The functioning of such a vibration welding operation is known in principle, so that this need not be dealt with in more detail at this point.

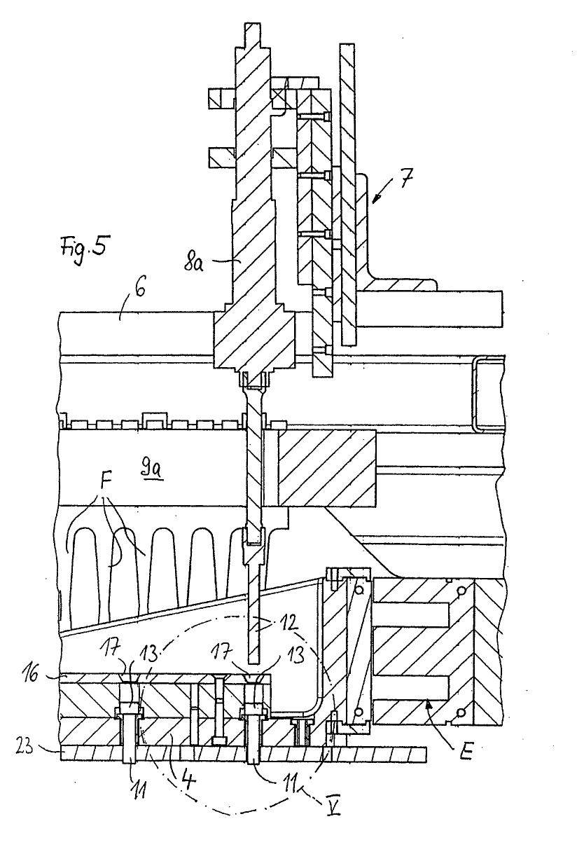

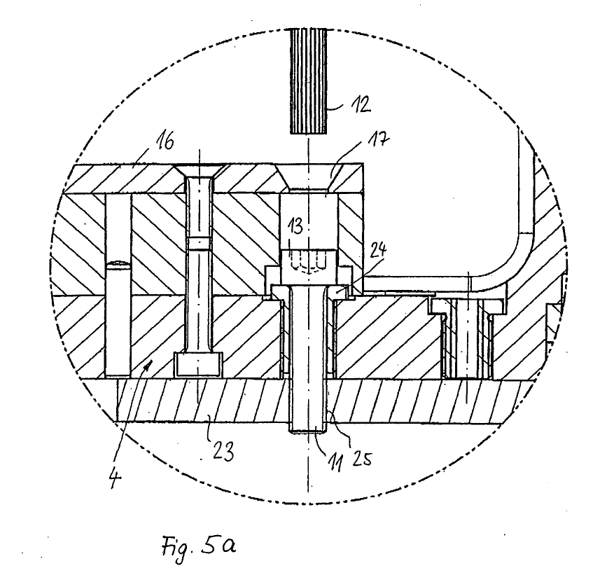

In order to be able to fasten a top tool 23 to the locating part 4, the top tool 23, on its top side facing the locating part 4, is provided with a multiplicity of fastening receptacles, arranged in a distributed manner over the base area of the top tool 23, in the form of tapped holes 25, into which fastening means in the form of cap screws 11 can be screwed, these fastening means being held in the locating part 4 and projecting downward beyond an underside of the locating part 4 (see in particular FIGS. 4, 5 and 5a). The cap screws 11 are inserted from above into through-holes of the locating part 4 and have screw heads 13 which are supported on a respective stop sleeve 24 inside a bottom through-hole designed as a tapped hole. The stop sleeve is screwed into a tapped hole of the locating part. The stop sleeve 24 is provided with a top stop collar, on which the screw head 13 rests. The holes are provided with diameters which are stepped from top to bottom, an inside diameter of the bottom through-hole being formed by an inside diameter of the stop sleeve. The annular stepped offset thus formed in each through-hole serves to seat the respective stop ring and thus to seat the screw head 13 of each cap screw 11.

As can be seen with reference to FIGS. 5 and 5a, the cap screws 11, in their screwed functional position, project beyond an underside of the locating part 4 and are screwed into a top base plate of the top tool 23. To this end, the base plate 23 of the top tool is provided with tapped holes 25, into which the screw shanks of the cap screws 11 are screwed.

As can also be seen with reference to FIGS. 4 and 5 and 5a, the locating part 4 is of multilayer construction, the hole sections of the through-holes being provided with different diameters in each case in different layer parts of the locating part 4. As can be seen with reference to FIGS. 5, 5a, the locating part 4 has a cover plate 16 which is firmly connected to the rest of the layer plates of the locating part 4. Provided in the cover plate 16 are centering sections 17 which are tapered conically downward and which, on the one hand, serve as a captive locking means for the cap screws 11 and, on the other hand, are intended for enabling the shank 12 of a screwdriver 8a, 8b to be centered when the shank 12 plunges into the corresponding through-hole of the locating part 4.

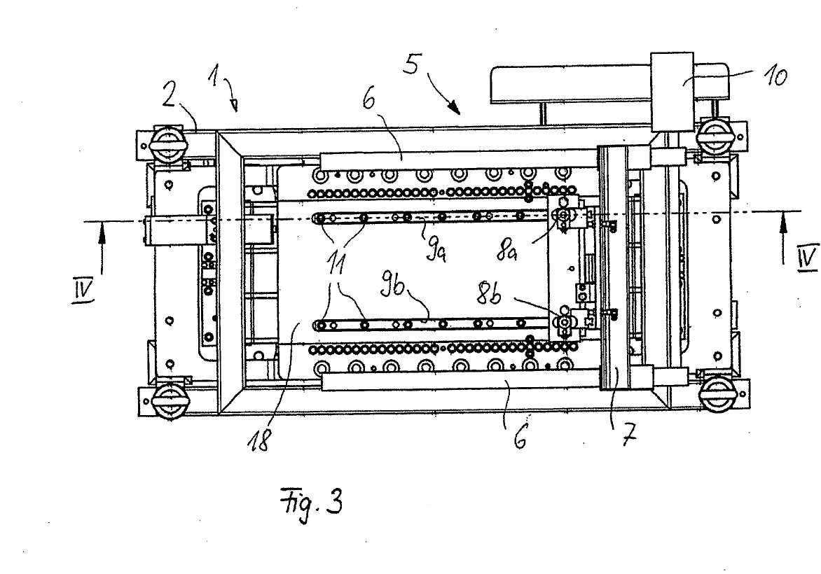

As can be seen with reference to FIG. 3, the top tool is mounted on the locating part 4 by means of two parallel rows of fastening points. In the exemplary embodiment shown, in each case seven spaced-apart cap screws 11 and a corresponding number of through-holes are provided in each row in the locating part 4, the cap screws 11 and the through-holes in each case being provided linearly in alignment in a row. As FIG. 3 shows, the two rows are oriented parallel to one another.

In order to permit automatic screwing-in and unscrewing of the cap screws 11 from above, a fastening tool arrangement 5, which has two screwdrivers 8a, 8b, is assigned to the locating part 4. The two screwdrivers 8a, 8b are each provided with a rotary drive 14 in the form of an air motor or pneumatic drive and are held in a guide slide 7 which is traversable on guide rails 6 parallel to the locating part 4 and along the two rows of cap screws 11. The guide slide 7 and the guide rails 6 form a guide arrangement within the scope of the invention. The guide slide 7 has a retainer (not designated), in which the two screwdrivers 8a, 8b are held in a rotatable manner. In addition, a reciprocating drive 15 is assigned to the retainer and permits a vertical movement, i.e. a stroke movement, of the screwdrivers 8a, 8b in order to permit a corresponding screw-in or unscrewing movement of the cap screws 11. The two screwdrivers 8a, 8b each have an extension shank 12, which is of two-piece design and is provided at its bottom end with appropriate tool application surfaces which engage in corresponding tool application surfaces of the screw heads 13. The extension shanks 12 are held in an axially movable manner inside the screwdrivers 8a, 8b and are under spring preloading in the screw-in direction, so that they are pressed against the tool engagement surfaces of the screw heads 13 in a positive manner. The retainer together with the screwdrivers 8a, 8b and the guide slide 7 and the guide rails 6 is arranged above the portal bridge 18, 21 on the supporting frame 19. Provided in a portal plate 18 of the portal bridge 18, 21 for each extension shank 12 is a respective longitudinal groove 9a which has a respective through-slot open at the top and the bottom. The two through-slots 9a, 9b are oriented parallel to one another and are arranged exactly in alignment above a respective row of cap screws 11 in the portal plate 18 in order to allow the screwdrivers 8a, 8b to reach the cap screws 11.

The guide slide 7 including the retainer and the screwdrivers 8a, 8b is traversable along the guide rails 6 in an infinitely variable or incremental manner by means of an actuator 10. By means of the actuator 10, the guide slide 7 is traversed relative to the locating part 4 in such a way that the extension shanks 12 of the two screwdrivers 8a, 8b are arranged exactly above a respective pair of cap screws 11. As soon as this position is reached, the two screwdrivers 8a, 8b are lowered by means of the reciprocating drive 15 and are set in rotation by their rotary drives 14 until the tool application surfaces of the extension shanks 12 engage in the corresponding tool application surfaces of the screw heads 13 in a positive-locking manner. Control elements, such as, in particular, control valves, are actuated by the contact pressure produced and release an axial movement of the extension shafts. As a result, the extension shanks, on account of the spring preloading which is now effective, are axially pressure-loaded downward and permit the follow-up movement of the extension shanks during a screw-in movement of the cap screws. The rotary drives effect the screw-in or unscrewing operation.

In an embodiment which is not shown, the stroke movement of each screwdriver 8a, 8b can be adjusted in its fine setting independently of a corresponding stroke movement of the other screwdriver 8a, 8b. As a result, it is possible to individually apply a downwardly acting pressure force to each screwdriver 8a, 8b in order to apply a corresponding pressure force and a corresponding torque to the respective cap screw 11.

Assigned to each rotary drive 14 is a torque sensor S₃, which, by measuring corresponding physical variables of the rotary drive, detects at least one instantaneous torque, preferably a maximum permissible torque, and correspondingly activates the rotary drive 14. After an appropriate tightening torque for the respective cap screw 11 has been reached, the respective screwdriver 8a, 8b is stopped and, together with the retainer, is moved upward either individually or together with the other screwdriver 8a, 8b. The next screwing point can now be approached.

In a further embodiment (not shown), there is no torque sensor. Rather, the screw-in torque of the extension shanks and of the screwdrivers is limited in such a way that the extension shanks stop when the appropriate tightening torque of the cap screws 11 is reached.

In order to permit fully automatic fitting or removal of the top tool, a stroke sensor S₂ is assigned to the reciprocating drive 15. In addition, a displacement sensor S₁ which detects the instantaneous position of the guide slide 7 is assigned to the actuator 10. In a manner not shown in any more detail, a data memory is provided in which the exact coordinates of each cap screw 11 are measured and preset within an imaginary, fixed coordinate system. In addition, at least one reference position of the guide slide 7 and at least one reference stroke position of the screwdriver 8a, 8b are defined and filed in the data memory. Corresponding characteristics for the locating part 4 are predetermined by means of these data, these characteristics being formed as a function of a configuration of the top tool and as a function of the positioning of corresponding tapped holes in the top tool and also as a function of the corresponding through-holes in the locating part 4.

The sensors S₁ to S₃ described are connected to a central control unit SE, which is designed as an electronic control unit and has in particular at least one microprocessor. The control unit SE is connected by means of control lines to the actuator 10, to the reciprocating drive 15 and to the rotary drives 14 in order to correspondingly activate the drives 10, 14, 15 as a function of the actual values, detected by the sensors S₁ to S₃, and corresponding setpoint/actual-value comparisons with the input data of the data memory. As a result, it is possible to screw the top tool to the locating part 4 in a fully automatic manner and to also release it again from the locating part 4 after vibration welding operations have accordingly been carried out.

1. A vibration welding machine having a machine frame, to which a locating unit for a bottom tool and a locating part for a top tool are assigned, the locating part for the top tool having a multiplicity of fastening points which are arranged in a distributed manner over its base area and to which the top tool can be fastened by means of a corresponding number of fastening means, wherein the top tool is provided with fastening receptacles (26) on its top side facing the locating part (4), and wherein fastening means (11, 13) are arranged in the locating part (4), which fastening means (11, 13) are directed toward the top tool and are matched to the fastening receptacles (26) in such a way that the fastening means (11, 13) can be connected to the fastening receptacles during fitting of the top tool.

2. The vibration welding machine as claimed in claim 1, wherein the fastening means (11, 13) are accessible from a top side of the locating part (4) and have tool application surfaces which enable a fastening tool (5, 8a, 8b, 12) to be applied from above.

3. The vibration welding machine as claimed in claim 2, wherein the fastening means provided are cap screws (11) which are held suspended in through-holes of the locating part (4) and project downward beyond an underside of the locating part (4).

4. The vibration welding machine as claimed in claim 2, wherein at least one screwdriver (8a, 8b) is arranged as fastening tool on the machine frame (2), which screwdriver (8a, 8b) is provided with a rotary drive (14) and can be fed in toward the cap screws (11) for a screw-in or unscrewing operation.

5. The vibration welding machine as claimed in claim 4, wherein the screwdriver (8a, 8b) is arranged in a guide arrangement (6, 7) in such a way as to be traversable in a plane parallel to a surface of the locating part (4).

6. The vibration welding machine as claimed in claim 5, wherein the guide arrangement (6, 7) is provided with at least one actuator (10).

7. The vibration welding machine as claimed in claim 4, wherein a reciprocating drive (15) is assigned to the screwdriver (8a, 8b) in order to vertically displace the screwdriver (8a, 8b).

8. The vibration welding machine as claimed in claim 4, wherein a control device (SE) is provided which activates the at least one rotary drive (14) and/or the at least one reciprocating drive (15) and/or the at least one actuator (10).

9. The vibration welding machine as claimed in claim 5, wherein a displacement sensor (S₁) is assigned to the guide arrangement (6, 7) and/or a stroke sensor (S₂) is assigned to the reciprocating drive, said displacement sensor (S₁) and said stroke sensor (S₂) being connected to the control device (SE).

10. The vibration welding machine as claimed in claim 9, wherein a torque sensor (S₃) which detects a tightening torque of the rotary drive (14) is assigned to the screwdriver (8a, 8b).

11. The vibration welding machine as claimed in claim 8, wherein the control device (SE) has a microprocessor which compares actual values of the sensors (S₁ to S₃) with setpoints of a data memory and activates the drives (10, 14, 15) as a function of the result of the respective setpoint/actual-value comparison.

12. The vibration welding machine as claimed in claim 11, wherein a spatial coordinate system in which at least one reference position of the at least one screwdriver (8a, 8b) and positions of the cap screws (11, 13) are defined in terms of coordinates is stored in the data memory.
